(19) United States
(12) Patent Application Publication
(10) Pub. No.: US 2009/0281736 A1
(43) Pub. Date: Nov. 12, 2009

(54) Method and apparatus for concurrent positive and negative actuation in structural health monitoring systems

(76) Inventor: Hyeung-Yun Kim, Palo Alto, CA (US)

Correspondence Address: PATENT OFFICE OF DR. CHUNG S. PARK, P. O. BOX 62312, SUNNYVALE, CA, 94088-2312, US

(21) Appl. No.: 12/387,993

(22) Filed: May 11, 2009

Related U.S. Application Data
(60) Provisional application No. 61/127,458, filed on May 12, 2008.

(51) Int. Cl. G06F 19/00

(52) U.S. Cl. 702/34

(57) ABSTRACT

Method and systems of monitoring structural health conditions by use of a plurality of patch sensors attached to an object, for concurrent positive and negative actuation for reducing the electromagnetic interference, the power consumption, and the size of the electronic platform in structural health monitoring. The method comprises the steps of generating the first and second actuation signals, the second actuation signal being approximately identical to the inverted signal of the first actuation signal; applying the voltage difference of the first and second actuation signals across two electrical terminals of a transmitter patch, by initiating the first actuation signal to one electrical terminal and at same time the second actuation signal to the other electrical terminal, so as to facilitate the generation of said stress wave within a structure; and receiving the sensor signals from the sensor patches to monitor the health conditions of the structure.

### CROSS REFERENCE TO RELATED APPLICATIONS

This application claims the benefit of U.S. Provisional Applications No. 61/127,458, entitled “Method and apparatus for reducing actuator interference in sensor singnals”, filed on May 12, 2008, which is hereby incorporated herein by reference in its entirety.

### BACKGROUND

The present invention relates to systems for monitoring and diagnosing structural health conditions, and more particularly to diagnostic network patch (DNP) systems for monitoring structural health conditions.

As all structures in service require appropriate inspection and maintenance, they should be monitored for their integrity and health condition to proling their life or to prevent catstrophic failure. The diagnostics and monitoring of structures, as that carried out in structural health monitoring (SHM), are often accomplished by the network of active sensors. The active sensors, such as diagnostic network patches and piezoelectric transducers, are often used as both actuators transmitting stress wave within a structure, and sensors developing the sensor signal in response to the stress wave. When damage occurs the associated actuator-sensor paths become affected. But the minimum distance of the transmission paths of the diagnostic network is limited by the electromagnetic interference, or crosstalk, of actuation signals to the sensor signals.

Also, the general tend is that existing wired SHM systems are changed to wireless SHM systems that can diagnose the structural elements of infrastructure, without the structural system being dismantled or the ground being excavated for inspection and monitoring. Wireless SHM systems, deployed scalably in the structural elements of infrastructure, need in-situ compact small electronic platforms for multiplexing the diagnostic patches attached to the structure, actuating the actuator patches and receiving the sensor signals from the the sensor patches. But the size of a high-voltage power-supply component included in each electronic platform, and the power consumption during actuating actuator patches, often hindered the scalable deployment of wireless SHM systems.

Accordingly, there is a need for a system that can improve the performance of SHM systems by reducing the electromagnetic interference, the power consumption and the size of the electronic platform, so that SHM systems can be smaller and more compact with longer usage life, and to be reliable in the interpretation of structural health conditions.

### SUMMARY OF THE DISCLOSURE

According to one embodiment of the present invention, a method of monitoring structural health conditions by use of a plurality of patch sensors attached to an object is provided, where each of the patch sensors is capable of at least one of transmitting a stress wave upon receipt of actuation signals and developing a sensor signal in response to said stress wave. The method includes: generating the first and second actuation signals, the second actuation signal being approximately identical to the inverted signal of the first actuation signal; applying the voltage difference between the first and second actuation signals across two electrical terminals of a transmitter patch, by initiating the first actuation signal to one electrical terminal and at same time the second actuation signal to the other electrical terminal, so as to facilitate the generation of said stress wave within a structure; and receiving the sensor signals from the sensor patches to monitor the health conditions of the structure. The health conditions include at least one selected from the group consisting of damage, impact, cavity, corrosion, local change of internal temperature and pressure, degradation of material, and delamination of a structure.

According to another embodiment of the present invention, a computer readable medium may carry one or more sequences of instructions for monitoring structural health conditions by use of a plurality of patch sensors attached to an object, where each of the patch sensors is capable of at least one of transmitting a stress wave upon receipt of actuator signals and developing a sensor signal in response to said stress wave. The execution of one or more sequences of instructions by one or more processors cause the one or more processors to perform the steps of: generating the first and second actuation signals, the second actuation signal being approximately identical to the inverted signal of the first actuation signal; applying the voltage difference between the first and second actuation signals across two electrical terminals of a transmitting patch, by initiating the first actuation signal to one electrical terminal and at same time the second actuation signal to the other electrical terminal, so as to facilitate the generation of said stress wave within structure; and receiving the sensor signals from the sensor patches to monitor the health conditions of a structure.

According to yet another embodiment of the present invention, a system for monitoring structural health conditions by use of a plurality of patch sensors attached to an object, each of the patch sensors being capable of at least one of transmitting a stress wave upon receipt of actuation signals and developing a sensor signal in response to said stress wave, includes a transmitter patch configured to receive the actuation signals of inverted polarities and to generate a stress wave from the actuation signals. The system also includes a sensor patch configured to receive the stress wave and to generate a sensor signal having a first portion corresponding to an electromagnetic interference cancelled out by accumulating the interferences of the actuation signals, and a second portion corresponding to the stress wave. The system also includes a processor in communication with the actuator patch and the sensor patch, wherein the processor is configured to provide the actuation signals and receive the sensor signal.

### BRIEF DESCRIPTION OF THE DRAWINGS

FIG. 1A is a schematic diagram of a SHM system for concurrent positive and negative actuation, including a pair of high-voltage amplifiers in accordance with one embodiment of the present teachings.

FIG. 1B is a schematic diagram of a SHM system for concurrent positive and negative actuation, including a pair of high-voltage amplifier and negative buffer in accordance with another embodiment of the present teachings.

FIG. 2A is a schematic diagram of a SHM system for concurrent positive and negative actuation, including a pair of high-voltage pulse generators in accordance with yet another embodiment of the present teachings.

FIG. 2B is a schematic diagram of a SHM system for concurrent positive and negative actuation, including a pair of high-voltage pulse generator and negative buffer in accordance with still another embodiment of the present teachings.

FIG. 3A is a schematic diagram of a SHM system for concurrent positive and negative actuation incorporated with multiplexing the actuator and sensor patches, including a pair of high-voltage amplifiers in accordance with another embodiment of the present teachings.

FIG. 3B is a schematic diagram of a SHM system for concurrent positive and negative actuation incorporated with multiplexing the actuator and sensor patches, including a pair of high-voltage amplifier and negative buffer in accordance with another embodiment of the present teachings.

FIG. 4A is a schematic diagram of a SHM system for concurrent positive and negative actuation incorporated with multiplexing the actuator and sensor patches, including a pair of high-voltage pulse generators in accordance with another embodiment of the present teachings.

FIG. 4B is a schematic diagram of a SHM system for concurrent positive and negative actuation incorporated with multiplexing the actuator and sensor patches, including a pair of high-voltage pulse generator and negative buffer in accordance with another embodiment of the present teachings.

### DETAILED DESCRIPTION OF THE PREFERRED EMBODIMENTS

Although the following detained description contains many specifics for the purposes of illustration, those of ordinary skill in the art will appreciate that many variations and alterations to the following detains are within the scope of the invention. Accordingly, the following embodiments of the invention are set forth without any loss of generality to, and without imposing limitation upon, the claimed invention.

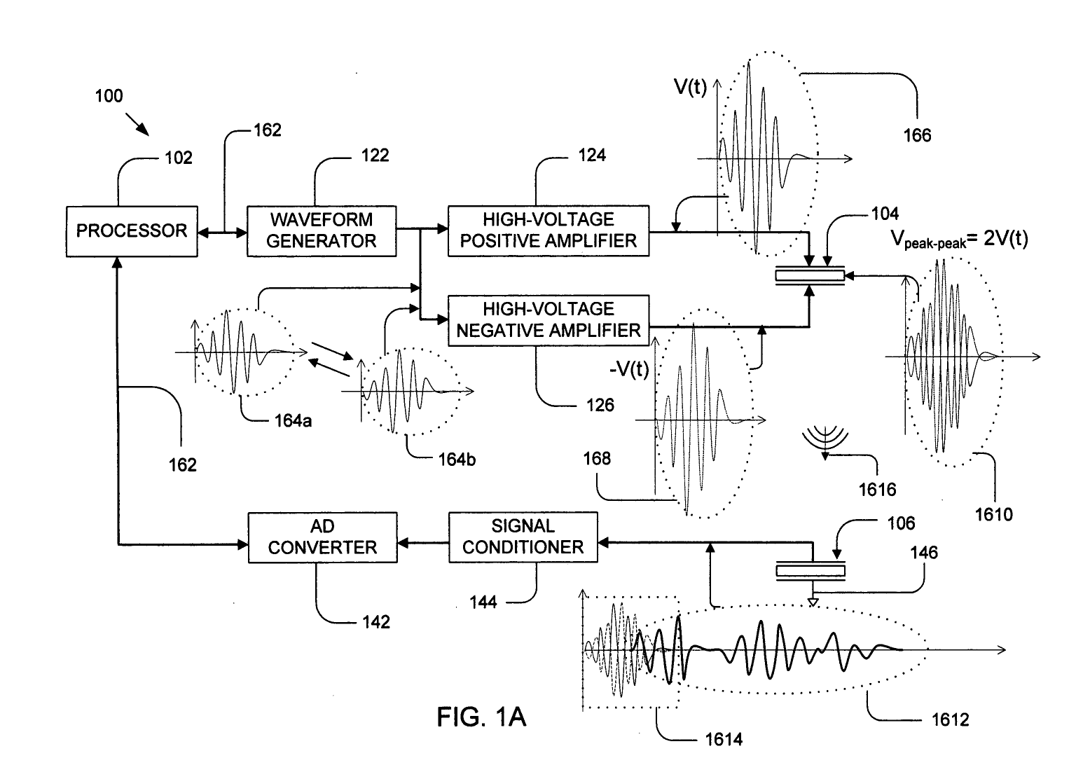

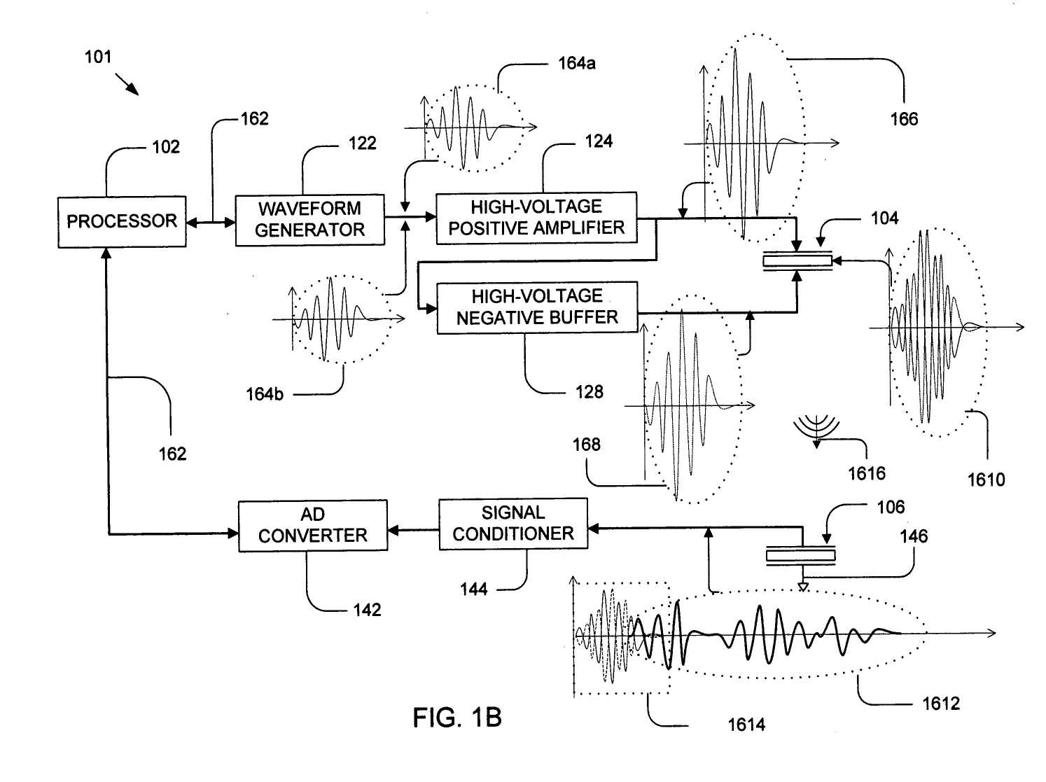

In one embodiment of the present invention, methods of reducing the electromagnetic interference and lowering the high-voltage level of a power supply component in a structural health monitoring system are described. FIG. 1A illustrates a structural monitoring system employing concurrent positive and negative actuation for reducing the electromagnetic interference and lowering the high-voltage level of a power supply component, according to one embodiment of the present invention. As depicted, a pair of actuation signals 166 and 168, with high voltage enough for the actuator patch 104 to generate the stress wave 1616 that can propagate to the sensor patch 106, is generated from a waveform input signal 164a. The opposite signal of each actuation signal 166 and 168 should be its “mirror” signal, i.e., one actuation signal is approximately identical to the inverted signal of the other actuation signal.

The pair of actuation signals 166 and 168 is sent concurrently to an actuator patch 104 by initiating the first actuation signal 166 to one electrical terminal and at same time the second actuation signal 168 to the other electrical terminal of the actuator patch, which results in applying the time-varying voltage difference of the actuation signals 166 and 168 across two electrical terminals of the actuator patch. The actuator patch 104 provides a vibratory motion according to the waveform of the applied voltage difference, so as to generate a stress wave 1616 when attached to a host structure. That is, the actuator patch 104 converts the applied voltage difference of two actuation signals 166 and 168 with opposite polarities to a stress wave 1616 that propagates through the structure, resulting in the transmission of the stress wave 1616 to at least one sensor patch 106. The actuation signal may be any suitable waveform signal, such as a toneburst signal and a bipolar pulse train with several peaks. The sensor patch 106 converts the transmitted stress wave to a sensor signal 1612. If only one actuation signal is used, a noise, or “crosstalk”, signal of electromagnetic interference may occur in the sensor signal when the actuator patch is energized by high voltage pulses. Concurrent positive and negative actuation makes the crosstalk signal be cancelled out because their noise signal components are accumulated in the sensor signal.

In one embodiment of the invention, methods of increasing clearability of the sensor signals of stress wave in concurrent positive and negative actuation are provided. In each sequence of concurrent positive and negative actuation, the actuator patch 104 alternatively employs the non-inverted waveform 164a and the inverted waveform 164b, so that the sensor patch 106 provides the senor signals generated by the corresponding waveform signals 164a and 164b. Then the sensor signals corresponding to the waveform signals 164a and 164b, which are alternatively switched between inverted and non-inverted, are accumulated to provide an averaged sensor signal of stress wave. Accumulating the sensor signals, alternatively generated by the non-inverted waveform signal 164a and the inverted waveform signal 164b, provides a high clearability of the sensor signals of stress wave, causing to filter out nuisance signals.

In the case where only one actuation signal is used, the voltage difference is equal to the amplitude of the actuation signal. But concurrent positive and negative actuation makes the voltage difference be approximately twice as large as the single actuation signal amplitude, resulting in the increase of the propagation distance of the stress wave by a factor of two compared to when only one actuation signal is applied. That is, given the distance between the actuator patch and the sensor patch, the actuator energized by two actuation signals, with the half of the signal amplitude of single actuation signal, can generate the same amount of elastic wave energy as that of the actuator energized by the single actuation signal. Thus we can lower by half the high-voltage level of the power supply component of high-voltage amplifiers or pulse generators included in a structural health monitoring system, allowing the form factor of the SHM system to be reduced.

In one embodiment of the invention, methods of monitoring the health conditions of a host structure by use of receiving “crosstalk-immune” sensor signals are described. Before processing the concurrent positive and negative actuation, a SHM system may form a diagnostic network including the patch sensors and a plurality of stress wave transmission paths, each said transmission path being a signal link between a transmitter patch and a sensor patch. The patch sensors may be attached to the host structure. The SHM system may cause the designated actuator patch to transmit the stress wave and the sensor patch to receive the crosstalk-immune sensor signals, and then analyze the crosstalk-immune sensor signals to determine the health conditions of the host structure. Based on the analysis of the crosstalk-immune sensor signals, the SHM system may optimize the diagnostic network for robust damage detection by routing the stress wave transmission paths of high sensitivity to damage. The methods of networking the diagnostic patches and optimizing their network are described in, for example, U.S. Pat. No. 7,286,964 to Kim, and U.S. patent application Ser. No. 11/509,198, filed on Aug. 23, 2006, which are hereby incorporated by reference in their entirety and for all purposes.

When the SHM system analyzes the crosstalk-immune sensor signal, the system may compare the received crosstalk-immune sensor signal to a crosstalk-immune baseline signal to determine a deviation therebetween, the crosstalk-immune baseline signal being measured by use of the diagnostic network in the absence of structural anomaly. Then the SHM system may perform a diagnostic data processing, such as generating a structural condition index and a tomographic image, with the crosstalk-immune sensor signals. In the procedure of performing diagnostic data processing, the SHM system may perform at least one of the steps of: extracting the first arrival wave packet from each sensor signal; generating damage probability-of-detection curves of the diagnostic network; optimizing the gain and frequency operating condition of the patch sensors; and compensating sensor signals for dynamic environmental change, which are also described in the previously referenced U.S. Pat. No. 7,286,964 to Kim. The derivation, applications, and limitations of damage Probability of Detection (POD) curves can be found in Health & safety Executive Research Report 454, 2006, by Jacobi Consulting Limited, entitled “Probability of Detection (POD) curves.”

Referring back to FIG. 1A, the structural health monitoring system 100 includes a waveform generator 122, controlled by a processor 102 through the data and control lines 162, capable of generating a waveform signal 164a or 164b, which is sent to two high-voltage amplifiers 124 and 126. The high-voltage positive and negative amplifier 124 and 126 generate the actuation signal 166 and the inverted actuation signal 168 by amplifying the waveform signal 164a or 164b, and then transmit two actuation signals of opposite polarities to the actuator patch 104 through their corresponding electrical terminals. The actuator patch 104 converts the combined actuation signal 1610 to a stress wave 1616 that propagates through a host structure to the sensor patch 106, whereas one electrical terminal of the sensor patch may be wired to the ground 146. Then the sensor patch 106, placed in a distance away from the actuator patch 104, converts the stress wave 1616 to the sensor signal 1612 corresponding to the stress wave transmitted to the sensor patch 106. However the crosstalk signal 1614 is cancelled out due to concurrent positive and negative actuation. The crosstalk-immune sensor signal may be amplified and/or filtered by a signal conditioner 144 as necessary (hereinafter, the term signal conditioner refers to an amplifier and/or filter), and passed on to an analog-to-digital converter (ADC) 142 controlled by a processor 102 through the data and control lines 162, resulting in the crosstalk-immune sensor data. Furthermore the sensor data may be analyzed and manipulated by a processor 102 as appropriate, according to the procedures explained above to analyze the crosstalk-immune sensor signal.

It is noted that the actuator patch 104 and the sensor patch 106 may be attached to a host structure. The noise signal 1614, which is generated by the electromagnetic interference of the actuation signal 166, is received before the sensor signal 1612. As the distance between the actuator patch and the sensor patch decreases, or the flight time of the stress wave between them becomes shorter, the noise signal 1614 and the sensor signal 1612 move close to each other. In some cases, two signals of 1612 and 1614 may overlap each other. In such cases, if the concurrent positive and negative actuation described above were not used in the system 100, the electromagnetic interference noise 1614 overlapping the sensor signal 1612 might cause false indication of damage by altering the sensor signal 1612 and resulting in invalid sensor readings. Thus, the concurrent positive and negative actuation technique enhances the reliability of the structural health monitoring systems by canceling the crosstalk signal 1614.

FIG. 1B illustrates a structural monitoring system employing concurrent positive and negative actuation, according to another embodiment of the present invention. A structural health monitoring system 101 illustrated in the FIG. 1B is similar to that illustrated in FIG. 1A, except for the high-voltage negative buffer 128, which generates the inverted actuation signal 168 by inverting the actuation signal 166. Then two actuation signals of opposite polarities are transmitted to the actuator patch 104 through their corresponding electrical terminals, resulting in reducing the electromagnetic interference and lowering the high-voltage level of a power supply component.

One of ordinary skill in the art will realize that a different embodiment of the present invention can employ different types of the actuator patch 104 and the sensor patch 106. For example, in the embodiments described above, the actuator patch 104 and the sensor patch 106 may include piezoelectric transducers. When affixed to a structure, these patches are capable of both converting the stress wave back to a voltage so that the prosperities of the stress wave propagated through the structure can be analyzed to monitor the health conditions of the structure. Also the actuator patch 104 and the sensor patch 106 can be actuators and sensors that are placed on a flexible dielectric substrate to form a diagnostic layer. However, a person of ordinary skill in the art will realize that the invention is not limited to these embodiments, and can encompass the use of any suitable type of actuator and sensor, such as magnetic actuators, fiber optic sensors and the like, which can be used to generate signals that can be combined so as to reduce the electromagnetic interference and lowering the high-voltage level of a power supply component.

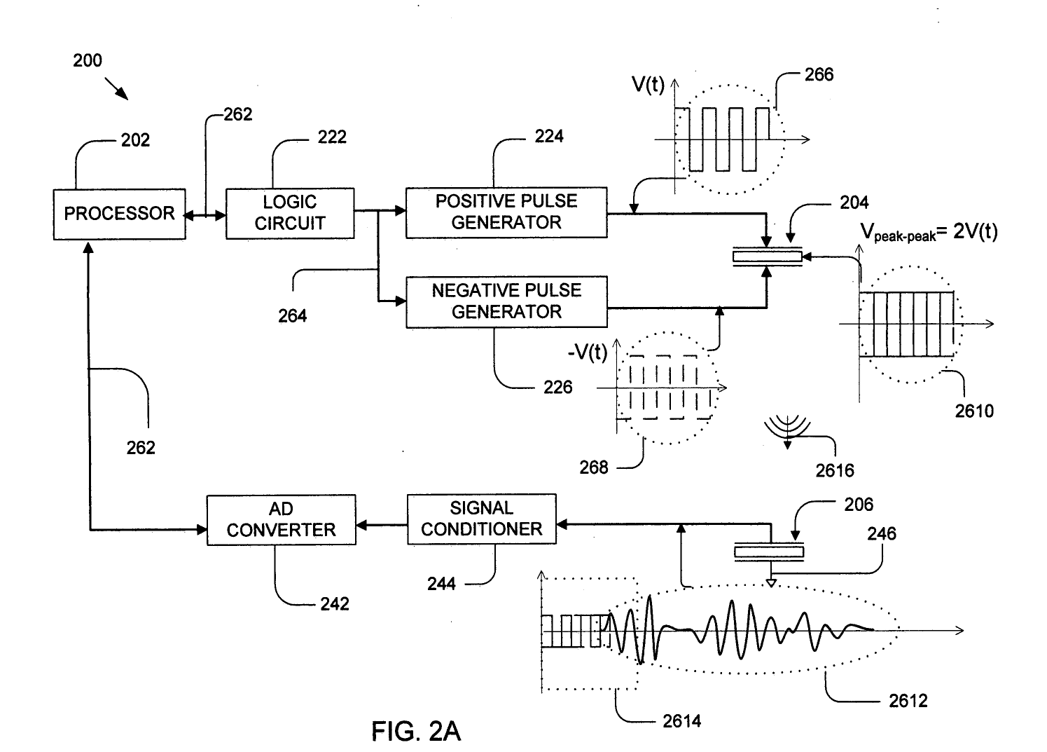

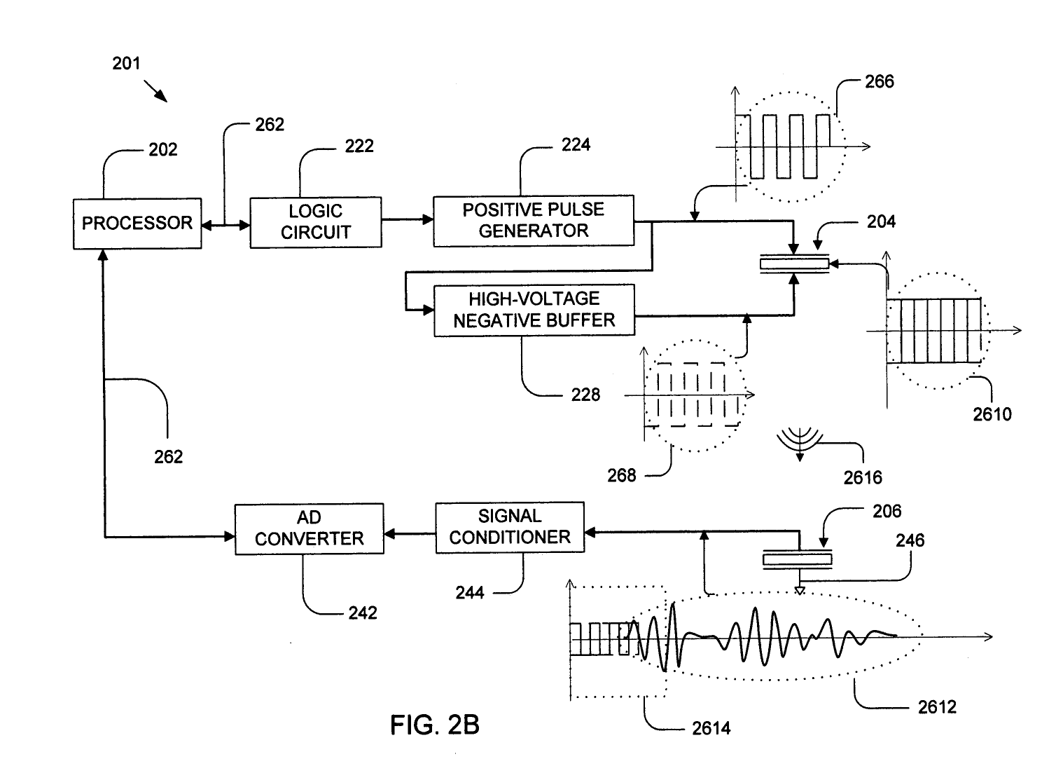

FIG. 2A illustrates a structural monitoring system utilizing at least one pulse generator, according to another embodiment of the present invention. A structural health monitoring system 200 includes a pulse generator 224, controlled by a logic circuit 222 through the data and control lines 262, capable of generating a bipolar pulse train with several peaks 266, which is sent to the actuator patch 204. If one electrical terminal of the actuator patch is wired to the ground 246, the actuator patch 204 converts the bipolar pulse train 266 to a stress wave 2616 that propagates through a structure to the sensor patch 206. Then the sensor patch 206 converts the stress wave 2616 to the sensor signal 2612 corresponding to the stress wave transmitted to the sensor patch 206, and also picks up the crosstalk signal 2614 caused by the electromagnetic interference of the bipolar pulse train 266.

The logic circuit 222, preferably including a field-programmable-gate-array (FPGA) or a complex-programmable-logic-device (CPLD), provides the clock and control signals to the pulse generator 224 through the control lines 264. The pulse generator 224, operated by the logic circuit 222, generates a bipolar pulse train, which is predetermined according to the wave parameters of time period or frequency, number of pulse-train peaks, and its amplitude. The SHM system 200 may employ other suitable kinds of the bipolar pulse trains generated by the logic circuit 222, such as a plain pulse signal, a pulse-width-modulated (PWM) pulse signal, a frequency-modulated pulse signal, a phase modulated pulse signal, a return-to-zero (RZ) binary signal and a non-return-to-zero binary (NRZ) signal. The pulse generator 224 may be a monolithic single channel, high speed and high voltage pulser, whose circuitry, packaged in a small electronic chip, consists of controller logic circuits, level transistors, gate driving buffers and a high current and high voltage MOSFET output stage. Any suitable pulse generators can be employed, regardless of whether the SHM system 200 is incorporated into a pulse generator based on high voltage MOSFET technology.

According to an embodiment of the present invention, the structural health monitoring system 200 further includes another pulse generator 226, also controlled by the logic circuit 222 through the control lines 262. The positive and negative pulse generators 224 and 226 generate the bipolar pulse train 266 and the inverted bipolar pulse train 268, and then transmit two actuation signals of opposite polarities to the actuator patch 204 through their corresponding electrical terminals. The actuator patch 204 converts the combined bipolar pulse train 2610 to a stress wave 2616 that propagates through a structure to the sensor patch 206. Then the sensor patch 206 converts the stress wave 2616 to the sensor signal 2612. However the crosstalk signal 2614 is also cancelled out due to concurrent positive and negative actuation.

FIG. 2B illustrates a structural monitoring system utilizing at least one pulse generator, according to another embodiment of the present invention. A structural health monitoring system 201 illustrated in the FIG. 2B is similar to that illustrated in FIG. 2A, except for the high-voltage negative buffer 228, which generates the inverted bipolar pulse train 268 by inverting the bipolar pulse train 266. Then two bipolar pulse train of opposite polarities are transmitted to the actuator patch 204 through their corresponding electrical terminals, resulting in reducing the electromagnetic interference and lowering the high-voltage level of a power supply component.

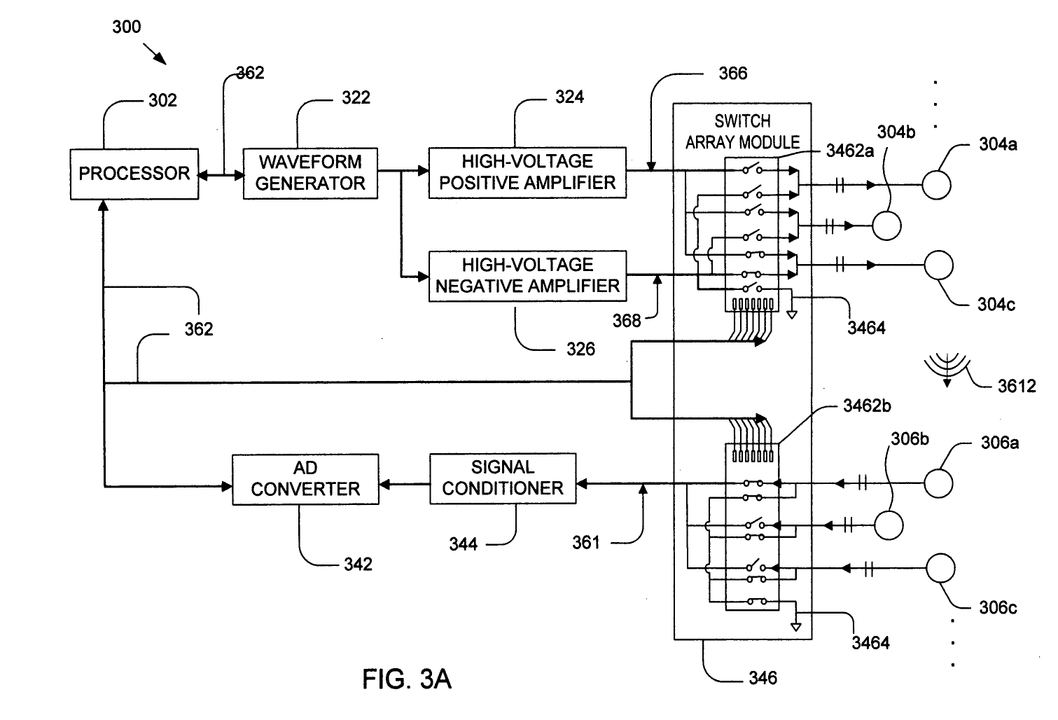

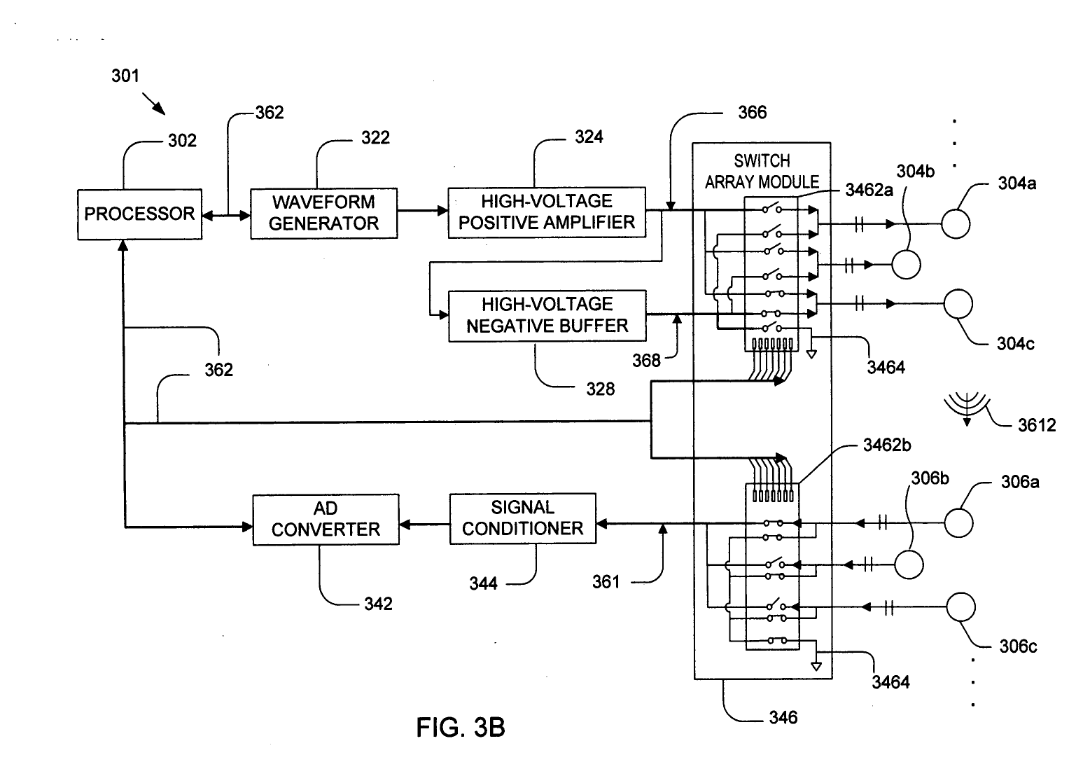

FIG. 3A illustrates a structural monitoring system employing concurrent positive and negative actuation, according to an embodiment of the present invention. A structural health monitoring system 300 includes a waveform generator 322, controlled by a processor 302 through the data and control lines 362, capable of generating a waveform signal sent to two high-voltage amplifiers 324 and 326. The high-voltage positive and negative amplifiers 324 and 326 generate the actuation signal and the inverted actuation signal. Then the amplifiers 324 and 326 transmit two actuation signals of opposite polarities to the actuator patch 304c, through the actuation lines 366 and 368, which is selected by choosing one of the switches of a switch array submodule 3462a contained in a switch array module 346. The actuator patch 304c transmits a stress wave 3612 to the sensor patch 306. Then the sensor patch 306a receives the sensor signal of the stress wave 3612, where one electrical terminal of the sensor patch may be switched through a switch array submodule 3462b, so as to be wired to the ground 3464. Accordingly, the crosstalk signal, possibly occurred in the sensor signal line 361, is cancelled out due to concurrent positive and negative actuation. The crosstalk-immune sensor signal may be amplified and/or filtered by a signal conditioner 344 as necessary, and passed on to an analog-to-digital converter (ADC) 342 controlled by a processor 302 through the data and control lines 362, resulting in the crosstalk-immune sensor data.

The switch array module 346 controlled by a processor 302 is configured to select a predetermined transmission path in a diagnostic network of the stress wave 3612, by multiplexing the actuator patches and the sensor patches. In the case where the actuator patches 304a-c work as a sensor patch, the actuation line 368 connected to the high voltage negative amplifier 326 is switched to be wired to a ground 3464. Also, in the case where the sensor patches 306a-c work as an actuator patch (not shown in the FIG. 3A), the positive and negative actuation lines 366 and 368 are connected to the switch array submodule 3462b so that the sensor patches 306a-c can receive the positive and negative actuation signals. The switch array submodule 3462a-b may be any suitable switch array device, such as a relay switch array or a high voltage analog switch integrated circuit (IC).

FIG. 3B illustrates a structural monitoring system employing concurrent positive and negative actuation, according to another embodiment of the present invention. A structural health monitoring system 301 illustrated in the FIG. 3B is similar to that illustrated in FIG. 3A, except for the high-voltage negative buffer 328, which generates the signal through the inverted actuation line 368 by inverting the signal of the actuation line 366. Then two actuation signals of opposite polarities are transmitted to the actuator patch 304c, through the actuation lines 366 and 368, which is selected by choosing one of the switches of a switch array submodule 3462a contained in a switch array module 346, resulting in reducing the electromagnetic interference and lowering the high-voltage level of a power supply component.

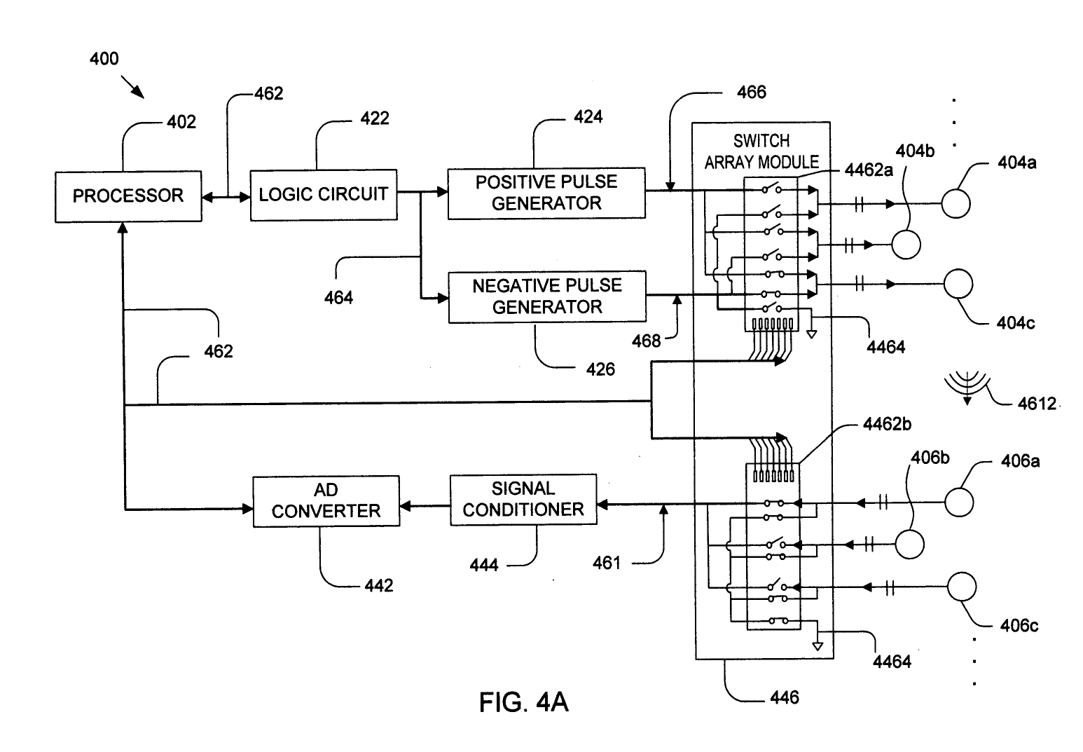

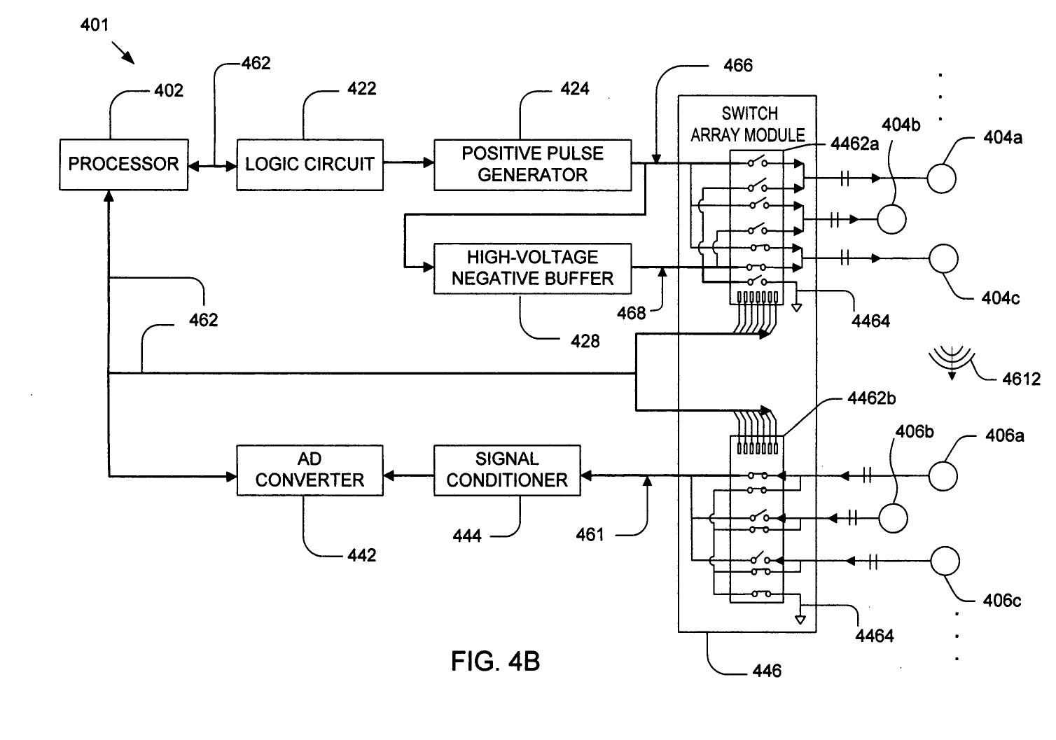

FIG. 4A illustrates a structural monitoring system having at least one pulse generator and switch array module, according to another embodiment of the present invention. A structural health monitoring system 400 includes the pulse generators 424 and 426, controlled by a logic circuit 422, through the data and control lines 462, capable of generating the bipolar pulse trains of opposite polarities sent to the actuator patch 404c, through the actuation lines 466 and 468. The logic circuit 422 provides the clock and control signals to the pulse generators 424 and 426 through the control lines 464. The actuator patch 404c is selected by choosing one of the switches of a switch array submodule 4462a contained in a switch array module 446. The actuator patch 404c transmits a stress wave 4612 to the sensor patch 406. Then the sensor patch 406a receives the sensor signal of the stress wave 4612, where one electrical terminal of the sensor patch may be switched through a switch array submodule 4462b, so as to be wired to the ground 4464. Accordingly, the crosstalk signal, possibly occurred in the sensor signal of the line 461, is cancelled out due to concurrent positive and negative actuation. The crosstalk-immune sensor signal may be amplified and/or filtered by a signal conditioner 444 as necessary, and passed on to an analog-to-digital converter (ADC) 442 controlled by a processor 402 through the data and control lines 462, resulting in the crosstalk-immune sensor data.

FIG. 4B illustrates a structural monitoring system utilizing at least one pulse generator and switch array module, according to another embodiment of the present invention. A structural health monitoring system 401 illustrated in the FIG. 4B is similar to that illustrated in FIG. 4A, except for the high-voltage negative buffer 428, which generates the inverted bipolar pulse train of the line 468 by inverting the bipolar pulse train of the line 466. Then two bipolar pulse train of opposite polarities are transmitted to the actuator patch 404c by selecting one of the switches of a switch array submodule 4462a contained in a switch array module 446, resulting in reducing the electromagnetic interference and lowering the high-voltage level of a power supply component.

The invention can also include the switch array module 446 that is incorporated into an electronic platform for wired and wireless SHM systems capable of multiplexing the actuator and sensor patches, so as to interrogate the damage of a structure by networking the transmission paths of a diagnostic stress wave. Such SHM systems and their operations are further described in, for example, U.S. Pat. No. 7,281,428 to Kim, which is hereby incorporated by the reference in its entirety and for all purposes. Electronic platforms and their operations for wireless SHM are also explained in U.S. patent application Ser. No. 12/214,896, filed on Jun. 23, 2008, which is also incorporated by reference in its entirety and for all purposes. However it should be noted that the present invention is not limited to the wired or wireless SHM systems described in the aforementioned U.S. Pat. No. 7,281,428, and U.S. patent application Ser. No. 12/214,896. Rather, any other suitable electronic modules and power supply sources to these SHM systems can be employed, regardless of whether the modules shown in the FIGS. 1A-4B are incorporated into the SHM system. The present invention simply contemplates any electronic modules and any power supply sources in any manner that allows for wired and wireless SHM systems according to the methods described herein. A skilled artisan will realize that many different combinations exist for implementing battery-powered and self-powered wireless SHM systems, not all of which employ wired SHM systems.

While the present invention has been described with reference to the specific embodiments thereof, it should be understood that the foregoing relates to preferred embodiments of the invention and that modifications may be made without departing from the spirit and scope of the invention as set forth in the following claims.

What is claimed is:

1. A method of monitoring structural health conditions by use of a plurality of patch sensors attached to an object, each said patch sensor being capable of at least one of transmitting a stress wave upon receipt of actuation signals and developing a sensor signal in response to said stress wave, comprising:
generating the first and second actuation signals, the second actuation signal being approximately identical to the inverted signal of the first actuation signal;
applying the voltage difference of the first and second actuation signals across two electrical terminals of a transmitter patch, by initiating the first actuation signal to one electrical terminal and at same time the second actuation signal to the other electrical terminal, so as to facilitate the generation of said stress wave within a structure; and
receiving the sensor signals from the sensor patches to monitor the health conditions of the structure.

2. The method of claim 1, further comprising:
preparing the non-inverted and inverted waveform signals of a waveform signal;
causing a transmitter patch to generating a stress wave corresponding to the waveform signal;
receiving the sensor signal of the stress wave;
repeating the steps of causing a transmitter patch and receiving the sensor signal, by alternating the non-inverted and inverted waveform signals; and
accumulating the sensor signals generated by the non-inverted and inverted waveform signals, resulting in an averaged sensor signal.

3. The method of claim 1, further comprising:
forming a diagnostic network including the patch sensors and a plurality of stress wave transmission paths, each said transmission path being a signal link between a transmitter patch and a sensor patch.

4. The method of claim 3, further comprising:
optimizing the diagnostic network for robust damage detection by routing the stress wave transmission paths of high sensitivity to damage.

5. The method of claim 1, further comprising:
analyzing the sensor signals to determine the health conditions of a structure.

6. The method of claim 5, whether the step of analyzing the sensor signals includes:
performing diagnostic data processing;
generating a structural condition index; and
generating a tomographic image.

7. The method of claim 6, whether the step of performing diagnostic data processing includes:
extracting the first arrival wave packet from each sensor signal;
generating damage probability-of-detection curves of the diagnostic network;
optimizing the gain and frequency operating condition of the patch sensors; and
compensating sensor signals for dynamic environmental change.

8. The method of claim 1, wherein the structural health conditions include at least one selected from the group consisting of damage, impact, cavity, corrosion, local change of internal temperature and pressure, degradation of material, and delamination of a structure.

9. The method of claim 1, wherein the actuation signal is at least one of a tonburst signal, a bipolar pulse train with several peaks, a pulse-width-modulated (PWM) pulse signal, a frequency-modulated pulse signal, a phase modulated pulse signal, a return-to-zero (RZ) binary and a non-return-to-zero binary (NRZ) signal.

10. A computer readable medium carrying one or more sequences of instructions for monitoring structural health conditions by use of a plurality of patch sensors attached to an object, each said patch sensor being capable of at least one of transmitting a stress wave upon receipt of actuator signals and developing a sensor signal in response to said stress wave, wherein execution of one or more sequences of instructions by one or more processors cause the one or more processors to perform the steps of:
generating the first and second actuation signals, the second actuation signal being approximately identical to the inverted signal of the first actuation signal;
applying the voltage difference of the first and second actuation signals across two electrical terminals of a transmitting patch, by initiating the first actuation signal to one electrical terminal and at same time the second actuation signal to the other electrical terminal, so as to facilitate the generation of said stress wave within structure; and
receiving the sensor signals from the sensor patches to monitor the health conditions of a structure.

11. The computer readable medium of claim 10, wherein execution of one or more sequences of instructions by one or more processors cause the one or more processors to perform the further steps of:
preparing the non-inverted and inverted waveform signals of a waveform signal;
causing a transmitter patch to generating a stress wave corresponding to the waveform signal;
receiving the sensor signal of the stress wave;
repeating the steps of causing a transmitter patch and receiving the sensor signal, by alternating the non-inverted and inverted waveform signals; and
accumulating the sensor signals generated by the non-inverted and inverted waveform signals, resulting in an averaged sensor signal.

12. The computer readable medium of claim 10, wherein the actuation signal is at least one of a tonburst signal, a bipolar pulse train with several peaks, a pulse-width-modulated (PWM) pulse signal, a frequency-modulated pulse signal, a phase modulated pulse signal, a return-to-zero (RZ) binary and a non-return-to-zero binary (NRZ) signal.

13. A diagnostic system for monitoring structural health conditions by use of a plurality of patch sensors attached to an object, each said patch sensor being capable of at least one of transmitting a stress wave upon receipt of actuation signals and developing a sensor signal in response to said stress wave, said system comprising:
a transmitter patch configured to receive the actuation signals of inverted polarities and so as to generate a stress wave from the actuation signals;
a sensor patch configured to receive the stress wave and to generate a sensor signal having a first portion corresponding to an electromagnetic interference cancelled out by accumulating the interferences of the actuation signals, and a second portion corresponding to the stress wave; and
a processor in communication with the actuator patch and the sensor patch, wherein the processor is configured to provide the actuation signals and receive the sensor signal.

14. A diagnostic system as recited in claim 13, further comprising:
at least one analog-to-digital converter(ADC) for converting the sensor signal to a digital signal.

15. A diagnostic system as recited in claim 13, further comprising:
at least one relay switch array module that has a plurality of switches, wherein the switches are adapted to establish a channel between a selected one of the sensor patch and the ADC.

16. A diagnostic system as recited in claim 13, further comprising:
a waveform generator configured to generate a waveform signal by receiving a diagnostic data from the processor.

17. A diagnostic system as recited in claim 16, further comprising:
at least one high-voltage amplifier to generate the actuation signals of inverted polarities from the waveform signal.

18. A diagnostic system as recited in claim 17, further comprising:
at least one high-voltage negative buffer to generate the actuation signals of inverted polarities from the waveform signal.

19. A diagnostic system as recited in claim 13, further comprising:
at least one pulse generator to generate the bipolar train signals of inverted polarities.
a logic circuit configured to control the pulse generators by receiving a control data from the processor.

20. A diagnostic system as recited in claim 19, further comprising:
at least one negative pulse buffer to generate the bipolar train signals of inverted polarities.

21. A diagnostic system as recited in claim 13, further comprising:
at least one relay switch array module that has a plurality of switches, wherein the switches are adapted to establish a channel between a selected one of the transmitter patch and the high-voltage amplifier.

22. A diagnostic system as recited in claim 13, further comprising:
at least one relay switch array module that has a plurality of switches, wherein the switches are adapted to establish a channel between a selected one of the transmitter patch and the pulse generator.

23. A diagnostic system as recited in claim 19, wherein the logic circuit further includes at least one of a field-programmable-gate-array(FPGA) and a complex-programmable-logic-device(CPLD).
at least one relay switch array module that has a plurality of switches, wherein the switches are adapted to establish a channel between a selected one of the transmitter patch and the pulse generator.

24. A diagnostic system as recited in claim 13, wherein the processor is further configured to:
form a diagnostic network including the patch sensors and a plurality of stress wave transmission paths, each said transmission path being a signal link between a transmitter patch and a sensor patch.

25. A diagnostic system as recited in claim 24, wherein the processor is further configured to:
optimize the diagnostic network for robust damage detection by routing the stress wave transmission paths of high sensitivity to damage.

26. A diagnostic system as recited in claim 13, wherein the processor is further configured to:
analyze the sensor signals to determine the health conditions of a structure.

27. A diagnostic system as recited in claim 26, wherein the processor is further configured to:
perform diagnostic data processing;
generate a structural condition index; and
generate a tomographic image.

28. A diagnostic system as recited in claim 27, wherein the processor is further configured to:
extract the first arrival wave packet from each sensor signal;
generate damage probability-of-detection curves of the diagnostic network;
optimize the gain and frequency operating condition of the patch sensors; and
compensate sensor signals for dynamic environmental change.

29. A diagnostic system as recited in claim 13, wherein the actuation signal is at least one of a tonburst signal, a bipolar pulse train with several peaks, a pulse-width-modulated (PWM) pulse signal, a frequency-modulated pulse signal, a phase modulated pulse signal, a return-to-zero (RZ) binary and a non-return-to-zero binary (NRZ) signal.
